(19) United States
(12) Patent Application Publication
(10) Pub. No.: US 2007/0055399 A1
(43) Pub. Date: Mar. 8, 2007

(54) AUDIO SWITCHING SYSTEM WITH INTERACTIVE PUPPET

(75) Inventors: ARIE LITBAK, REHOVOT (IL); YANIV PETEL, HERZELIA (IL); ILAN MORAD, PETACH TIKVA (IL); EYTAN MORAD, PETACH TIKVA (IL); ASSAF GIL, RISHON LE ZION (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: UNITY INTERACTIVE LLC, LOS ANGELES, CA (US)

(21) Appl. No.: 11/421,486

(22) Filed: Jun. 1, 2006

Related U.S. Application Data
(60) Provisional application No. 60/713,738, filed on Sep. 6, 2005.
(60) Provisional application No. 60/790,822, filed on Apr. 11, 2006.

(51) Int. Cl. G06F 17/00

(52) U.S. Cl. 700/94

(57) ABSTRACT

An audio switching system alternately directs an input audio signal to an audio output and to a remote puppet. The system includes an audio switching arrangement with a transmitter and a puppet including a receiver, an amplifier and a speaker. The audio switching arrangement includes an electronic switch electrically switchable between a straight-through state wherein the audio signal from the audio input is transferred to the audio output and a diverted state wherein the audio signal from the audio input is transferred to the transmitter for transmitting to the puppet. A signal processor, associated with the audio input, responds to a predefined actuation signal superimposed on the audio signal as part of the electrical signal from the audio input to switch the electronic switch from the straight-through state to the diverted state. The frequency and/or duration of the actuation signal is preferably chosen to render the actuation signal substantially non-intrusive to the hearing of the user.

This application claims the benefit of provisional patent application No. 60/713,738 filed 6 Sep. 2005, and of provisional patent application No. 60/790,822 filed 11 Apr. 2006.

### FIELD AND BACKGROUND OF THE INVENTION

The present invention relates to audio and audio-visual entertainment systems and, in particular, it concerns an audio switching system with an interactive puppet.

It is known to provide interactive puppets where audio content for playing on the puppet is included within the stereo soundtracks. Examples of such systems include the following:

U.S. Pat. No. 6,519,444 (Jang) teaches a system with multiple animated toys where one channel of a stereo audio recording is used for the soundtrack and the other channel is used to store digital “call signals”. The soundtrack is broadcast to all of the toys, but the toys are selectively muted by the control signals so that only a selected toy generates the required audio. There is no switching of audio signals between a television and the animated toys.

U.S. Pat. No. 5,655,945 (Jani) teaches a video-tape-player system in which additional data for operating an interactive doll is stored on vacant spaces in the tape and recovered by a special decoder. Here again, the connection from the player to the television is direct, bypassing the decoder, and no switching of audio channel supplied to the television takes place.

U.S. Pat. No. 5,636,994 (Tong) teaches a computer-based interactive doll where one of the audio channels is hard-wired for transmission to the doll. Again, no selective switching of any channel between the doll and the regular audio output occurs.

U.S. Pat. No. 5,191,615 (Aldava et al.) teaches an arrangement where the television is hard-wired directly to the input, and where the doll audio and animation signals are recovered by a complex demodulator unit. No switching of the audio signals supplied to the television seems to take place.

U.S. Pat. No. 4,846,693 (Baer) teaches an animated figure operated in conjunction with a video recorder. The audio from the video recorder is played exclusively through the decoder box, directed either to an internal speaker or to the animated figure. The volume control of the television must be turned down to minimum in order not to interfere with operation of the system.

U.S. Pat. No. 4,840,602 (Rose) teaches a system including an animated doll which employs a speech synthesizer and preprogrammed vocabulary stored in memory.

Thus, in general, existing implementations of interactive puppets are highly complex and require sophisticated processing of the audio track content to recover the puppet audio data. None of the documents known to the inventors teaches a simple switching arrangement in which one audio channel of a stereo soundtrack is selectively switched between regular connection to a television and transmission to a puppet.

There is therefore a need for an audio switching system which would provide a simple and low-cost solution for selective transmission of part of an audio track to a remote puppet, and which would allow normal operation of the audio system while the puppet is not in use without degrading the quality of the audio.

### SUMMARY OF THE INVENTION

The present invention is an audio switching arrangement for providing an audio signal selectively to at least one audio output and to a remote puppet.

According to the teachings of the present invention there is provided, an audio switching system for receiving an electrical signal including an audio signal from at least one audio input, and for providing the audio signal selectively to at least one audio output and to a remote puppet, the switching arrangement comprising: (a) a transmitter for transmitting a wireless signal conveying at least the content of the audio signal; (b) a puppet including: (i) a receiver for receiving the wireless signal, (ii) an amplifier for amplifying audio content derived from the wireless signal, and (iii) a speaker for outputting the audio content; (c) an electronic switch electrically switchable between a straight-through state wherein the audio signal from the audio input is transferred to the audio output and a diverted state wherein the audio signal from the audio input is transferred to the transmitter for transmitting to the puppet; and (d) a signal processor associated with the at least one audio input and configured to be responsive to a predefined actuation signal superimposed on the audio signal as part of the electrical signal from the audio input to switch the electronic switch from the straight-through state to the diverted state.

According to a further feature of the present invention, the signal processor is configured to be responsive to a predefined non-intrusive actuation signal. According to various implementations of the invention, the non-intrusive actuation signal may be a predefined actuation signal in a frequency range between about 15 kHz and about 20 kHz, a predefined actuation signal in a frequency range below about 30 Hz, or a predefined actuation signal transmitted intermittently and having a duration no longer than about 0.2 seconds.

According to a further feature of the present invention, the signal processor is configured to be responsive to an analogue actuation signal corresponding to a tone at a predefined frequency.

According to a further feature of the present invention, the signal processor is configured to switch the electronic switch between the straight-through state and the diverted state in a first direction at an onset of the tone and in an opposite direction on termination of the tone.

According to a further feature of the present invention, the signal processor is configured to decode data from a digital actuation signal encoded within a predefined frequency band.

According to a further feature of the present invention, the signal processor is configured to derive from the data an indication of a currently required state of the electronic switch.

According to a further feature of the present invention, the signal processor is configured to be responsive to a first state of the predefined actuation signal to switch to or maintain the diverted state of the electronic switch and to a second state of the predefined actuation signal to switch to or maintain the straight-through state of the electronic switch.

According to a further feature of the present invention, there is also provided an electro-mechanical switch deployed for selectively connecting the audio input to the electronic switch and bypassing the electronic switch to connect the audio input directly to the audio output, wherein the signal processor is further responsive to a presence of either of the first and second states of the actuation signal to switch the electro-mechanical switch to connect the audio input to the electronic switch, and is further responsive to an absence of the actuation signal to switch the electro-mechanical switch to bypass the electronic switch.

According to a further feature of the present invention, a de-energized state of the electro-mechanical switch bypasses the electronic switch to connect the audio input directly to the audio output.

According to a further feature of the present invention, there is also provided a filter deployed for removing the actuation signal from the electronic signal prior to outputting of the audio signal via the puppet.

According to a further feature of the present invention, for use with at least two audio inputs and at least two audio outputs, the electronic switch is configured such that, in the straight-through state, the audio signal from each of the audio inputs is transferred to the corresponding audio output, and in the diverted state, the audio signal from a first of the audio inputs is transferred to the transmitter for transmitting to the puppet while the audio signal from a second of the audio inputs is transferred to both of the audio outputs.

According to a further feature of the present invention, for use with at least two audio inputs and at least two audio outputs, the signal processor is configured to identify the actuation signal on an electrical signal received from either of the audio inputs, and wherein the electronic switch is responsive to the signal processor to selectively divert either the first audio signal or the second audio signal to the transmitter.

There is also provided according to the teachings of the present invention, a method for providing audio signals selectively to an audio output and to a remote puppet, the method comprising: (a) monitoring at least one electrical signal received from an audio input for a predefined actuation signal superimposed on the audio signals; (b) in the absence of the predefined actuation signal, outputting an audio signal from the electrical signal to the audio output; and (c) on detection of the predefined actuation signal, diverting the audio signal from the electrical signal to a transmitter for transmission to the remote puppet.

According to a further feature of the present invention implemented with stereo audio inputs and stereo audio outputs: (a) in the absence of the predefined actuation signal, an audio signal from each of the stereo inputs is transferred to a corresponding stereo output; and (b) on detection of the predefined actuation signal, an input from a first of the stereo inputs is diverted to the transmitter for transmission to the remote puppet while the input from a second of the stereo inputs is directed to both of the stereo outputs.

According to a further feature of the present invention, the predefined actuation signal is selected from the group consisting of: a predefined actuation signal in a frequency range between about 15 kHz and about 20 kHz; a predefined actuation signal in a frequency range below about 30 Hz; and a predefined actuation signal transmitted intermittently and having a duration no longer than about 0.2 seconds

### BRIEF DESCRIPTION OF THE DRAWINGS

The invention is herein described, by way of example only, with reference to the accompanying drawings, wherein:

FIGS. 1A and 1B are schematic representations of an implementation of an audio switching arrangement, constructed and operative according to the teachings of the present invention, for selectively providing an audio signal to an audio output and to a remote puppet, FIG. 1A showing the regular audio output state and FIG. 1B showing the remote puppet audio state; and

FIG. 2 is a block diagram showing a more detailed representation of a preferred implementation of an audio switching system constructed and operative according to the teachings of the present invention.

### DESCRIPTION OF THE PREFERRED EMBODIMENTS

The present invention is an audio switching system for providing an audio signal selectively to an audio output and to a remote puppet.

The principles and operation of audio switching systems according to the present invention may be better understood with reference to the drawings and the accompanying description.

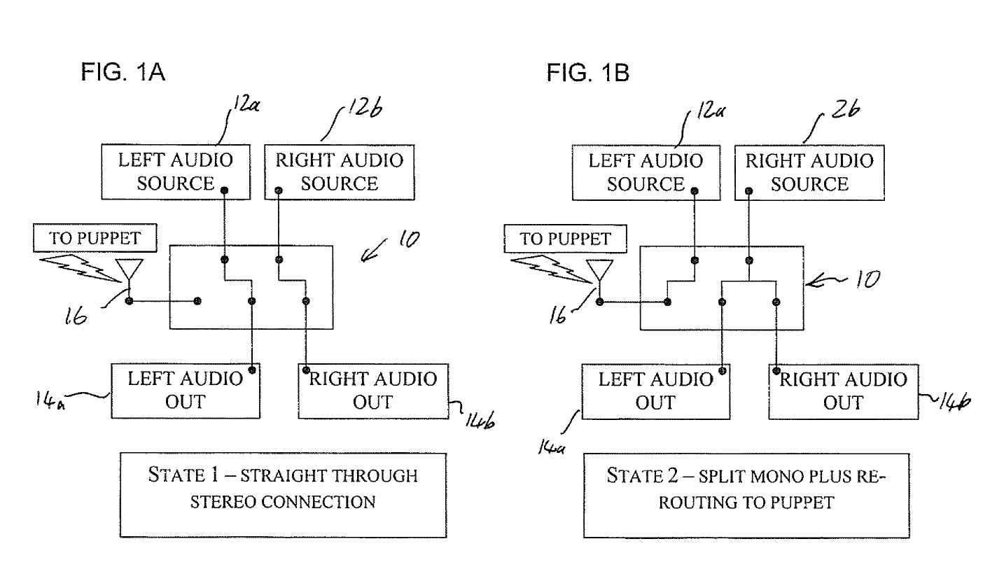

Referring now to the drawings, FIGS. 1A and 1B illustrate schematically the underlying principle of the present invention. Specifically, FIGS. 1A and 1B show a switching arrangement 10, constructed and operative according to the teachings of the present invention, deployed between audio inputs 12a, 12b and audio outputs 14a, 14b. In a first state as illustrated in FIG. 1A, switching arrangement 10 transfers audio signals from each audio input 12a, 12b to the corresponding audio output 14a, 14b. In a second state as illustrated in FIG. 1B, audio signals from one of the audio inputs 12a are redirected to a transmitter 16 for transmission to a remote puppet (to be described below). Most preferably, audio signals from the second audio input 12b are split to provide split mono audio to both audio outputs 14a, 14b.

Switching between the two states of FIGS. 1A and 1B is preferably performed dynamically during the programming on the basis of an actuation signal added to the audio channel for signaling the switching between modes. The actuation signal is chosen to be non-intrusive to the audio experience of most users, even if played via regular audio equipment. In certain cases, particularly where frequencies near or beyond the upper range of the audible frequency range are used, the actuation signal may be removable by simple filtering techniques with minimal impact on the quality of the audio content itself. At the same time, the actuation signal is chosen to be in the range of frequencies which are reliably reproduced by the sound recording and transmission techniques in common usage in audio and audio-visual entertainment systems, thereby allowing the actuation system to be added to the soundtrack of given programming without requiring any modification of the storage format or any other system hardware.

At this stage, it will be appreciated that the present invention provides a number of significant advantages over the existing interactive puppet technologies exemplified above. Specifically, it will be noted that:
The implementation is simple and robust, avoiding the need for any complex processing of the audio channel content. Essentially all that is required is circuitry for sensing the actuation signal to activate switching, a suitable switch, and standard short-range wireless transmission technology similar to that used in conventional wireless speakers.
Since the only modification of the audio tracks beyond the audio content itself is selective addition of a non-intrusive actuation signal (e.g., near or slightly beyond the upper or lower extreme of the audible frequency range so as to be inaudible to many users, and/or of brief duration), playing of the content on a conventional entertainment system (without the switching arrangement) would result in an acceptable playback effect with the puppet audio being played via one speaker of the entertainment system. It is therefore feasible to broadcast programming suitable for the system on public broadcast networks for which not all users are equipped with the system.
For “normal” programming without the actuation signal for signaling switching, the switching arrangement maintains the normal stereo audio connections, thereby rendering the presence of the system completely unintrusive to normal operation of the entertainment system.

Before turning to the features of the invention in more detail, it will be useful to define certain terminology as used herein in the description and claims. Firstly, reference is made herein to an “entertainment system” with which the present invention is used. Entertainment systems relevant to the present invention include all types of audio and audio-visual entertainment systems including, but not limited to: video entertainment systems where the source of the video programming is a cable decoder, a satellite decoder, an RE receiver, a DVD player, a digital or analogue VCR player, a computer system or a wide area communication network (WAN); and audio entertainment systems where the source of the audio programming is a cable decoder, a satellite decoder, an RF receiver, a CD or DVD player, a digital or analogue tape player, a computer system or a wide area communication network (WAN). The typical positioning of the switching arrangement of the present invention is between the audio source (e.g., decoder, receiver, player) and the playback/output device (e.g., television, amplifier etc.). In the case of an audio-visual entertainment system, the present invention preferably does not in any way modify the video signals which may either connect straight-through the switching arrangement or may be routed around the switching arrangement.

Reference is made to an “electrical signal” including an “audio signal”. The term “audio signal” is used to refer to a signal which can be amplified and output through a speaker to generate desired audio content. The “electrical signal” which includes the audio signal may be identical to the audio signal, or may have an additional signal superimposed upon it, such as the actuation signal of the present invention.

The term “superimposed” is used herein to refer to the combination of two or more signals, typically by summation. This term does not necessarily imply simultaneous content of the signals to be combined and, indeed, according to one optional implementation which will be described below, an actuation signal may in fact be superimposed specifically during momentary lulls (silence or low sound intensity) in the audio content of the audio signal.

The actuation signal of the present invention is preferably a “non-intrusive” actuation signal. The phrase “non-intrusive” is used herein to define a signal which, when superimposed on a soundtrack, does not significantly disrupt the listening experience of most users. There exist a number of different options for implementing a non-intrusive actuation signal according to the teachings of the present invention. According to a first set of preferred implementations, the actuation signal is defined within a frequency range between about 15 kHz and about 20 kHz. These frequencies are above the range of frequencies audible to many users, thereby minimizing the disturbance to the user. These frequencies are also advantageous in that they can be removed by simple low-pass filtering techniques without significantly impacting the audio quality of the resulting audio track.

According to a second set of preferred implementations, the actuation signal is defined within a frequency range below about 30 Hz, and more preferably below about 20 Hz, so as to be inaudible to many users.

According a third set of preferred implementations, the actuation signal may even be encoded within the range of frequencies audible to most users. In this case, the actuation signal is preferably added to the soundtrack intermittently, particularly at lulls in the audio where the audio soundtrack has silence or at least low volume. The actuation signal is preferably rendered relatively non-intrusive by use of a signal of short duration, preferably no longer than about 0.2 seconds, more preferably less than about 0.1 seconds, and typically in the range of a few tens of milliseconds.

The term “interactive puppet” is used herein to refer to a puppet which outputs part of an audio track supplied by an audio or audio-visual entertainment system. The puppet is referred to as “interactive” in the sense that selective output of audio by the puppet is used to give the user an impression that the puppet is “interacting” with other characters or objects represented in the remainder of the audio or video. It should be noted that the “puppet” need not take any specific form or perform any activity other than generate the required audio. By way of non-limiting examples, the puppet may be any type of puppet, doll, figurine, or a representation of an inanimate object (e.g., a talking train) with which an audio output is associated for given programming.

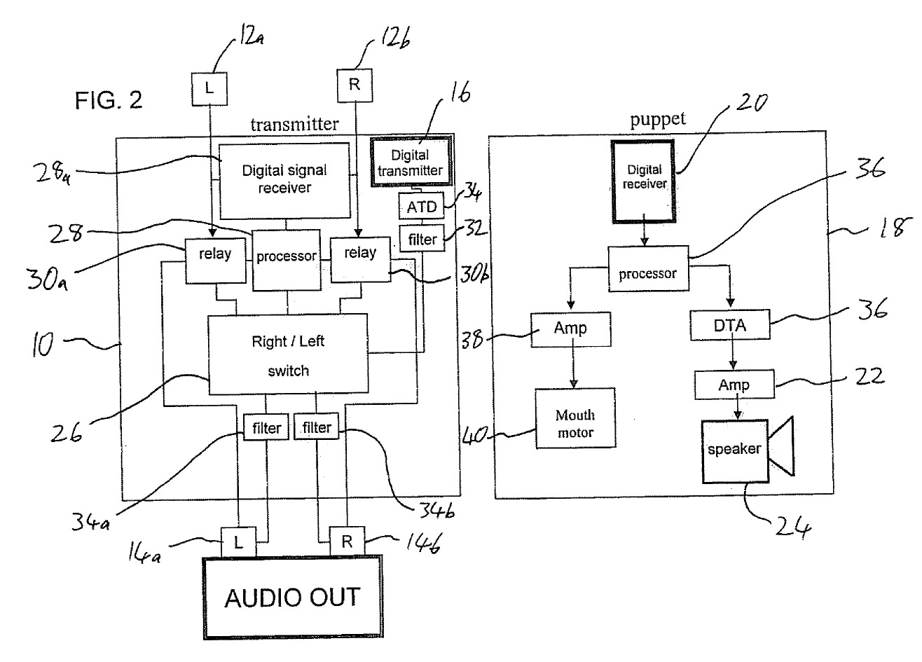

Turning now to FIG. 2, this illustrates a preferred implementation of the system of the present invention in more detail. In addition to switching arrangement 10, the system also shows a puppet 18 which includes a receiver 20 for receiving a wireless signal from transmitter 16, an amplifier 22 for amplifying audio content derived from the wireless signal, and a speaker 24 for outputting the audio content.

Switching arrangement 10 includes an electronic switch 26 electrically switchable between a straight-through state, wherein the audio signals from audio inputs 12a, 12b are transferred to corresponding audio outputs 14a, 14b, and a diverted state, wherein the audio signal from one of audio inputs 12a, 12b is transferred to transmitter 16 for transmitting to puppet 18. By way of a non-limiting preferred example, the invention is illustrated here with a signal processor 28 is configured to be responsive to a predefined actuation signal in a range of frequencies between about 15 kHz and about 20 kHz superimposed on the audio signal as part of the electrical signal from the audio input 12a or 12b to switch the electronic switch from the straight-through state to the diverted state. The modifications required for an alternative implementation of the present invention using one of the other types of non-intrusive actuation signal mentioned above will be self-evident to one ordinarily skilled in the art.

In a simple implementation of the invention, the predefined actuation signal may be an analogue signal, typically corresponding to a tone at a predefined frequency within the stated band. In this case, signal processor 28 is configured to be responsive to the presence of tone at the predefined frequency. It will be clear to one ordinarily skilled in the art that sensing of the presence of a tone at a specific frequency can be performed using standard electronic components by employing a narrow band-pass filter, rectifying the signal, smoothing the signal, and comparing it (e.g., by a differential amplifier) to a reference voltage threshold. The signal processor 28 then typically switches electronic switch 26 between the straight-through state and the diverted state in a first direction at an onset of the tone and in an opposite direction on termination of the tone. Alternatively, switching may be performed in alternate directions on occurrence of an intermittent tone, or each state may be positively identified by a predefined sequence, length or repetition frequency of on/off pulses of the tone, or of any other predetermined coding of the tone.

In order to facilitate additional functionality (to be described below) and render the system more resistant to noise within the electrical signals, certain particularly preferred implementations of the present invention employ a digital actuation signal. Since very low data rates, in the order of a few bits per second, are typically sufficient for the present invention, a narrow bandwidth (range of frequencies) is typically required. The digital data is recovered by a digital signal receiver 28a, which is shown as a separate box, but which may optionally be implemented as an integral part of processor 28. The components for digital signal receiver 28a to allow decoding and recovery of data from the digital actuation signal are well known in the art. Signal processor 28 derives from the recovered data an indication of a currently required state of the electronic switch, preferably positively designating either the straight-through or diverted switching state. Thus, a preferred implementation of the signal processor using a digital actuation signal identifies at least three different states:
digital signal with first code—straight-through switching state;
a digital signal with second code—diverted switching state; and
no digital signal present—programming not designated for use with the interactive puppet of the present invention.

Signal processor 28 is configured to be responsive to the first code to switch to, or maintain, the diverted state of electronic switch 26 and to the second code to switch to, or maintain, the straight-through state of electronic switch 26. Optionally, the digital data may carry additional data for operating various additional functions of the system such as, for example, movements of the puppet.

The positive identification of the two switching states during the programming is useful for a number of reasons. Firstly, the successful recovery of a digital code identifying the required switching state introduces a high level of immunity to background noise or other interference. Secondly, inclusion of the codes repeatedly (e.g., typically every few seconds) during the programming ensures that the system immediately identifies the required state of switching when a user starts her entertainments system in the middle of a program. Finally, the positive identification of both switching states allows differentiation between the straight-through switching state during programming intended for the interactive puppet and other programming not intended for use with the puppet, thereby allowing these to be handled differently, as will be described below.

Referring still particularly to FIG. 2, switching arrangement 10 preferably further includes one or more electro-mechanical switch, typically implemented as one or more relay 30a and 30b. These are deployed to as to selectively connect respective audio inputs 12a, 12b to electronic switch 26, or to bypass electronic switch 26, instead connecting the audio inputs directly to the corresponding audio outputs 14a, 14b. Relays 30a and 30b are actuated by signal processor 28 so as to connect the inputs to electronic switch 26 while an actuation signal is sensed (indicative of either the straight-through or diverted switching state), and so as to bypass electronic switch 26 when actuation signal is absent, thereby providing a direct electrical conductor connection between audio inputs 12a, 12b and audio outputs 14a, 14b. Although the “straight-through” switching state of the electronic switch typically has minimal impact on the sound quality of the audio signals, the provision of relays to bypass all electronic components and give a wired connection between inputs and outputs ensures that even any slight degradation introduced by the electronic components is avoided during programming not intended for use with the interactive puppet.

Clearly, the functions of relays 30a and 30b can be performed either by two separate relays, or by a single relay with multiple connections. Most preferably, relays 30a and 30b are configured so that their de-energized state corresponds to the bypass connection state where the audio inputs are connected directly to the audio outputs. This ensures that the switching arrangement 10 is unobtrusive even in the event that its power supply fails, since it leaves the inputs and outputs directly electrically connected.

As mentioned before, the actuation signal is preferably chosen to be inherently non-intrusive to the hearing of the user, even when not removed from the output soundtrack. In the particular example illustrated here of an actuation signal encoded in a frequency range above about 15 kHz, the actuation signal is easily removed by simple filtering techniques which do not significantly affect the audio output sound quality. This implementation of the present invention therefore preferably provides filtering to remove the relevant range of frequencies. Thus, a filter 32 is preferably deployed for removing the actuation signal from the electronic signal prior to outputting of the audio signal via puppet 18. In the implementation illustrated here, filter 32 is deployed as part of switching arrangement 10 interposed between electronic switch 26 and transmitter 16. Also shown here are output filters 34a and 34b which remove the actuation signals from the output from electronic switch 26 to audio outputs 14a and 14b. It will be noted that the positioning of the filters can vary. For example, the filters could be located between relays 30a, 30b and electronic switch 26. The filter on the puppet output could alternatively be located within the puppet 18.

While the system of the present invention is illustrated here in the common case of stereo audio, it should be noted that it is equally applicable both to mono sound systems and to multiple track “surround” audio systems with four or more tracks. In the case of mono, switching to the diverted state simply leaves the regular audio output quiet until the puppet audio has finished. In the case of two or more tracks, the diverted track is preferably substituted by splitting one of the other audio inputs into split mono as illustrated schematically in FIG. 1B. In the preferred implementation of FIG. 2, the electronic switch is preferably symmetrical, allowing diversion of either audio input to the puppet. This ensures that the device is insensitive to incorrect connection of the audio leads. Typically, the actuation signal is added to whichever channel is to be selectively diverted.

Turning now to the remaining features of switching arrangement 10, transmitter 16 is preferably a digital transmitter and receiver 20 is correspondingly a digital receiver, thereby offering considerable immunity to household electromagnetic interference. To enable digital transmission, switching arrangement 10 includes an analogue-to-digital converter (“ATD”) 34. Similarly, in preparation for amplification of the sound output, puppet 18 includes a processor 38 which passes the digital sound signals to a digital-to-analogue converter (“DTA”) 36. All of these components are standard items, similar to those used in many cordless telephones and other common wireless household communication systems.

As a further optional feature, puppet 18 as shown here includes an amplifier 40 and mouth motor 42 which receive an output from processor 38 and operate together to actuate movement of a mouth of the puppet as a function of the presence, volume level or other parameters derived from the audio signal. Clearly, actuators (not shown) may additionally or alternatively be provided to generate other types of movement of the puppet in response to the received audio signal or according to additional control signals transmitted to the puppet.

At this stage, the operation of switching arrangement 10 and puppet 18 will be clearly understood. On receipt of electrical signals from audio inputs 12a and 12b, digital signal receiver 28a monitors for the predefined actuation signal. When no actuation signal is detected, processor 28 leaves relays 30a and 30b de-energized so that inputs 12a, 12b are directly connected to audio outputs 14a, 14b as if the switching arrangement was not present. When an actuation signal is detected, it's digital content is retrieved and transferred to processor 28. Processor 28 then actuates relays 30a and 30b so as to connect the inputs to the electronic switch 26 and sets the state of the switch according to the content and source channel of the actuation signal. If a first predefined code is received, electronic switch 26 maintains the “straight-through” connection with the output again being directed to audio outputs 14a, 14b. If a second predefined code is received, the corresponding channel is diverted to filter 32, ATD 34 and then transmitted via transmitter 16 to receiver 20 for playing via DTA 36, amplifier 22 and speaker 24. The non-diverted channel is then split and output to both audio outputs 14a, 14b.

It will be appreciated that the above descriptions are intended only to serve as examples, and that many other embodiments are possible within the scope of the present invention as defined in the appended claims.

What is claimed is:

1. An audio switching system for receiving an electrical signal including an audio signal from at least one audio input, and for providing the audio signal selectively to at least one audio output and to a remote puppet, the switching arrangement comprising:
(a) a transmitter for transmitting a wireless signal conveying at least the content of the audio signal;
(b) a puppet including:
(i) a receiver for receiving said wireless signal,
(ii) an amplifier for amplifying audio content derived from said wireless signal, and
(iii) a speaker for outputting said audio content;
(c) an electronic switch electrically switchable between a straight-through state wherein the audio signal from the audio input is transferred to the audio output and a diverted state wherein the audio signal from the audio input is transferred to said transmitter for transmitting to said puppet; and
(d) a signal processor associated with the at least one audio input and configured to be responsive to a predefined actuation signal superimposed on the audio signal as part of the electrical signal from the audio input to switch said electronic switch from said straight-through state to said diverted state.

2. The audio switching arrangement of claim 1, wherein said signal processor is configured to be responsive to a predefined non-intrusive actuation signal.

3. The audio switching arrangement of claim 1, wherein said signal processor is configured to be responsive to a predefined actuation signal selected from the group consisting of: a predefined actuation signal in a frequency range between about 15 kHz and about 20 kHz; a predefined actuation signal in a frequency range below about 30 Hz; and a predefined actuation signal transmitted intermittently and having a duration no longer than about 0.2 seconds.

4. The audio switching arrangement of claim 1, wherein said signal processor is configured to be responsive to a predefined actuation signal in a frequency range between about 15 kHz and about 20 kHz.

5. The audio switching arrangement of claim 1, wherein said signal processor is configured to be responsive to a predefined actuation signal in a frequency range below about 30 Hz.

6. The audio switching arrangement of claim 1, wherein said signal processor is configured to be responsive to a predefined actuation signal transmitted intermittently and having a duration no longer than about 0.2 seconds.

7. The audio switching arrangement of claim 1, wherein said signal processor is configured to be responsive to an analogue actuation signal corresponding to a tone at a predefined frequency.

8. The audio switching arrangement of claim 7, wherein said signal processor is configured to switch said electronic switch between said straight-through state and said diverted state in a first direction at an onset of said tone and in an opposite direction on termination of said tone.

9. The audio switching arrangement of claim 1, wherein said signal processor is configured to decode data from a digital actuation signal encoded within a predefined frequency band.

10. The audio switching arrangement of claim 9, wherein said signal processor is configured to derive from said data an indication of a currently required state of said electronic switch.

11. The audio switching arrangement of claim 1, wherein said signal processor is configured to be responsive to a first state of said predefined actuation signal to switch to or maintain said diverted state of said electronic switch and to a second state of said predefined actuation signal to switch to or maintain said straight-through state of said electronic switch.

12. The audio switching arrangement of claim 11, further comprising an electro-mechanical switch deployed for selectively connecting the audio input to said electronic switch and bypassing said electronic switch to connect the audio input directly to the audio output, wherein said signal processor is further responsive to a presence of either of said first and second states of said actuation signal to switch said electro-mechanical switch to connect the audio input to said electronic switch, and is further responsive to an absence of said actuation signal to switch said electro-mechanical switch to bypass said electronic switch.

13. The audio switching arrangement of claim 12, wherein a de-energized state of said electro-mechanical switch bypasses said electronic switch to connect the audio input directly to the audio output.

14. The audio switching arrangement of claim 1, further comprising a filter deployed for removing said actuation signal from the electronic signal prior to outputting of the audio signal via said puppet.

15. The audio switching arrangement of claim 1 for use with at least two audio inputs and at least two audio outputs, wherein said electronic switch is configured such that, in said straight-through state, the audio signal from each of the audio inputs is transferred to the corresponding audio output, and in said diverted state, the audio signal from a first of the audio inputs is transferred to said transmitter for transmitting to said puppet while the audio signal from a second of said audio inputs is transferred to both of the audio outputs.

16. The audio switching arrangement of claim 1 for use with at least two audio inputs and at least two audio outputs, wherein said signal processor is configured to identify the actuation signal on an electrical signal received from either of the audio inputs, and wherein said electronic switch is responsive to said signal processor to selectively divert either the first audio signal or the second audio signal to the transmitter.

17. A method for providing audio signals selectively to an audio output and to a remote puppet, the method comprising:
(a) monitoring at least one electrical signal received from an audio input for a predefined actuation signal superimposed on the audio signals;
(b) in the absence of the predefined actuation signal, outputting an audio signal from the electrical signal to the audio output; and
(c) on detection of the predefined actuation signal, diverting the audio signal from the electrical signal to a transmitter for transmission to the remote puppet.

18. The method of claim 17 implemented with stereo audio inputs and stereo audio outputs, wherein:
(a) in the absence of the predefined actuation signal, an audio signal from each of the stereo inputs is transferred to a corresponding stereo output; and
(b) on detection of the predefined actuation signal, an input from a first of the stereo inputs is diverted to the transmitter for transmission to the remote puppet while the input from a second of the stereo inputs is directed to both of the stereo outputs.

19. The method of claim 17, wherein the predefined actuation signal is selected from the group consisting of: a predefined actuation signal in a frequency range between about 15 kHz and about 20 kHz; a predefined actuation signal in a frequency range below about 30 Hz; and a predefined actuation signal transmitted intermittently and having a duration no longer than about 0.2 seconds.
